(19) United States
(12) Patent Application Publication
(10) Pub. No.: US 2003/0169240 A1
(43) Pub. Date: Sep. 11, 2003

(54) Character input apparatus and method

(75) Inventor: Han Bok Song, Gumi-si (KR)

Correspondence Address: FLESHNER & KIM, LLP, P.O. Box 221200, Chantilly, VA, 20153-1200, US

(73) Assignee: LG Electronics Inc.

(21) Appl. No.: 10/383,769

(22) Filed: Mar. 10, 2003

(30) Foreign Application Priority Data
Mar. 11, 2002 (KR) 2002/13054

(51) Int. Cl. G09G 5/00

(52) U.S. Cl. 345/173

(57) ABSTRACT

The present invention relates to electronic, electric, and communication devices requiring a user to input characters, more particularly to, a character input apparatus and method to receive characters using shapes of characters. The character input apparatus according to the present invention recognizes the characters using selection order or selection combination corresponding to the character shape inputted from touch sensors or buttons by the user to input a character and displays the recognized character on a screen.

### BACKGROUND OF THE INVENTION

1. Field of the Invention

The present invention relates to a character input apparatus and method in which a character is inputted by using shapes of characters or loci depending on input orders of characters, or a character is recognized and displayed and to recognize characters by using patterns or orders of inputted characters in electronic, electric, and communication devices needing character input.

2. Discussion of the Related Art

Generally, electronic, electric, and communication devices requiring to input characters includes personal computers (PCs) and mobile communication terminals (for example, PDA, cellular phone terminal, etc.). In most of PCs, since characters are inputted using keyboards, a user no noticeable difficulties to input characters. However, for portable convenience, mobile communication terminals have small area to input characters and also does not have enough keys to input characters.

Accordingly, various characters are correspondingly allocated to a limited number of keys. A user repeats manipulation (for example, press or touch) of the same key so that the desired character is inputted. Or the user writes the character on a screen and the device recognizes the written character on the screen so that the character is inputted.

FIG. 1 is a schematic view of arrangement and structure of a keypad to illustrate character input method using the keypad of the mobile communication terminal. Such a keypad 100 usually has 3×4 matrix structure of 12 keys 110 including ten number keys (10-key) and two special keys (*, #). Each key represents a few Hangul (Korean alphabet) characters or a few English alphabets. The user repeats manipulation of the same key so that the desired character is inputted.

For example, the number key ‘2’ is used for ‘A’, ‘B’, ‘C’ as well as number ‘2’. In English input mode, whenever the key ‘2’ is pressed, the representation of the key is changed as follows: ‘A’ ‘B’ ‘C’ ‘A’ . . . so that the desired character can be inputted. And, to input small letters, all the user has to do is switch its mode into small letter mode and whenever the key ‘2’ is pressed, the representation of the key is changed as follows: ‘a’ ‘b’ ‘c’ ‘a’ . . . so that the desired small letter can be inputted.

Accordingly, to input Hangul or English alphabet with twelve keys, the manipulation of key should be repeated by a few or tens times so that it takes much time to input characters and it is very inconvenient.

### SUMMARY OF THE INVENTION

Accordingly, the present invention is directed to a character input apparatus and method that substantially obviates one or more problems due to limitations and disadvantages of the related art.

An object of the present invention is to provide a character input apparatus and method in which characters are inputted and recognized based on the peculiar shapes of the characters.

Another object of the present invention is to recognize characters based on the order of touch sensors corresponding to inputted characters.

Another object of the present invention is to recognize and display characters using combination of touch sensors corresponding to inputted characters.

Another object of the present invention is to recognize and display characters according to the selection order of buttons pressed in accordance to the shape of character using 3×3 matrix of the prepared buttons on a keypad.

Another object of the present invention is to recognize and display characters using combination of selected buttons pressed in accordance to the shape of character using 3×3 matrix of the prepared buttons on a keypad.

Another object of the present invention is to provide a character input apparatus and method that has a minimal number of sensors or buttons as character input means and enhances convenience to input characters and recognition ratio by recognizing characters based on the user's hand writing order of the character input means.

Another object of the present invention is to provide a character input apparatus and method that allows the user to input characters very easily without any training, decodes immediately point information inputted from touch sensors in a writing order, and recognizes the characters.

Another object of the present invention is to provide a character input apparatus and method that allows the user to input characters by writing them without any character input means such as character input pen, maps the inputted writing order onto database, and recognizes the characters based on mapping information.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a character input apparatus includes a sensor means for sensing a hand's touch of a user who writes characters to input the characters; a character recognition and control means for recognizing the inputted character according to touch order of the sensor means; a storage means for storing data of the recognized character; and a display means for displaying the stored data of the character recognized by the character recognition and control means on a screen.

It is desired that the sensor means is a touch sensor and the sensor means comprises five touch sensors arranged at four corners of a rectangle and a center of the rectangle.

It is desired that the character recognition and control means compares a touch order of the sensors with character correspondence touch order data stored in a memory and recognizing the character;

It is desired that the character recognition and control means decodes the touch order of the sensor means and recognizes the character.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a structure of a key pad of a general mobile communication terminal;

FIG. 2 illustrates an example of a key pad of a mobile communication terminal to which a character input apparatus according the present invention is applied;

FIG. 3 illustrate an example of a character input sensing sensor and a sensing device of a key pad of a mobile communication terminal to which a character input apparatus according the present invention is applied;

FIG. 4 is a flowchart of an embodiment of a method for recognizing characters according the present invention;

FIG. 5 illustrates an example of characters recognized according to sensing order and position of five touch sensors of the present invention;

FIGS. 6a though 6c illustrate other examples of characters recognized according to sensing order and position of five touch sensors of the present invention;

FIG. 7 illustrates another embodiment of a character input apparatus that has six touch sensors arrangement according the present invention;

FIG. 8 illustrates another embodiment of a character input apparatus that has nine touch sensors arrangement according the present invention;

FIG. 9 illustrates examples of recognition of characters using a character input sensing sensor according to the embodiments shown in FIGS. 7 and 8;

FIGS. 10a through 10c illustrate examples of recognition of characters using a character input sensing sensor according to the embodiments shown in FIGS. 7 and 8;

FIG. 11 illustrates another embodiment of a character input apparatus that has 3×3 matrix according the present invention;

FIGS. 12a and 12b illustrate examples of recognition of characters according to the embodiment shown in FIG. 11; and

FIG. 13 illustrates recognition of characters according to another embodiment of the present invention.

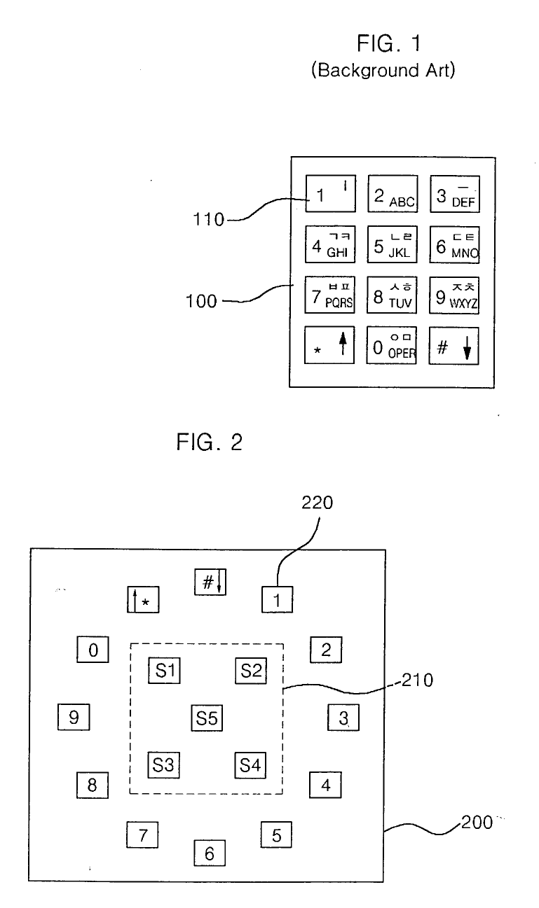

### DETAILED DESCRIPTION OF THE INVENTION

Reference will now be made in detail to the preferred embodiments of the present invention, examples of which are illustrated in the accompanying drawings.

FIG. 2 illustrates an example of a keypad of a mobile communication terminal to which a character input apparatus according the present invention is applied.

Referring to FIG. 2, a keypad 200 of a mobile communication terminal includes a character input unit 210 and twelve keys 220 including ten keys (0˜9) and two special keys (*, #). The character input unit 210 has five sensors S1 to S5 arranged at four corners of rectangle and a center of the rectangle and rectangle.

In other words, four sensors S1, S2, S3 and S4 of five sensors S1, S2, S3, S4 and S5 are arranged at the corners and the remaining one sensor S5 is arranged at the center of the rectangle.

The sensors S1 to S5 is comprised of touch sensors as an embodiment. The touch sensor senses touches of a human body and is used as a means to recognize a character in points, which a user writes directly with a finger.

In the character input paths using five sensors, each of the orders of at least 2 sensor touches and at most 5 sensor touches can be a character input path. In other words, a touch order of two sensors can be one character input path and a touch order of all the five sensors can also be one character input path.

In addition, character recognition depending on the touch order can be applied to different languages and depends on the writing order of character. In other words, characters can be recognized using touch order that has at most five points and varies continuously according to writing order (locus) of characters.

The character recognition is an embodiment. Since the writing order depends on a user, various touch orders of each character are stored deliberately and the right character can be recognized by comparison.

The character recognition is an embodiment. The touch order patterns of users are stored additionally using repeat learning statistics of erroneous and normal input characters and the right character can be recognized by comparison and analysis.

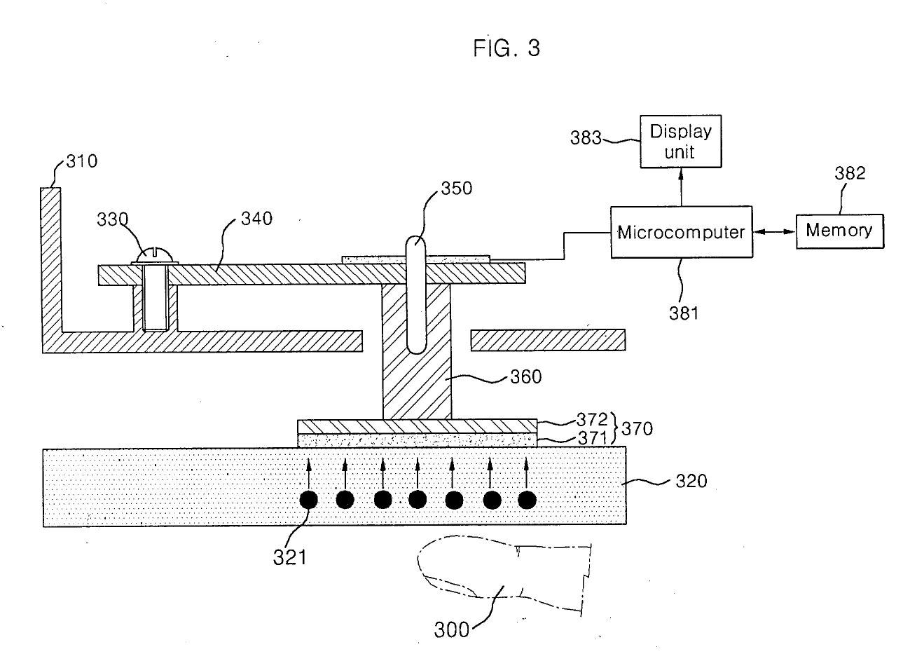

FIG. 3 illustrates a structure of a touch sensor and a device recognizing characters according the present invention.

Referring to FIG. 3, the touch sensor includes a glass substrate 320 installed and spaced from a front surface of a front cabinet 310, a print circuit board 340 fixed on a back surface of the cabinet 310 with a screw 330, a charging layer 370 including a silver layer 371 and a ceramic layer 372 to cause to charge electricity 321 inside of the glass substrate 320, and a conductive rubber 360 having one end contacted with the ceramic 372 and the other end embedding a metal pin 350 and contacted with the print circuit board 340.

This touch sensor transfers a small amount of current that is generated by charged electricity 321 caused when the user's finger is contacted with the glass substrate 320 to the conductive rubber 360. The small amount of the transferred current is transferred to a microcomputer 381 via the metal pin 350 and the print circuit board 340 as a touch point.

The microcomputer 381 recognizes a character according to a locus caused by a sensor contact and a touch order of the touch sensor, stores a recognized character in the memory 382, and controls a display unit 383 to display the stored character.

For this, the microcomputer 381 receives successively the touch points corresponding to the small amount of current caused by charged electricity generated by the touch sensor, and can recognize the human body (finger) contact and the touch order of the touch sensors S1 to S5.

The touch order of the touch sensors S1 to S5 recognized by the microcomputer 381 is decoded into the character set deliberately corresponding to the touch order. As an embodiment, the touch order is compared with the stored character correspondence touch order data and what character is inputted is recognized.

The memory 382 stores the character data recognized by the microcomputer 381 or the character correspondence touch order data to recognize characters deliberately. The recognition and/or stored character data are displayed to the user using the display unit 383.

Here, the memory 382 stores character data that can be inputted according to touch order of the five sensors. In other words, the character data is stored deliberately corresponding to successive order of the sensors touched when the user inputs character. As an embodiment, the first touched sensor and the last touched sensor for each character can be stored as character data in different touch orders according to the user's input pattern.

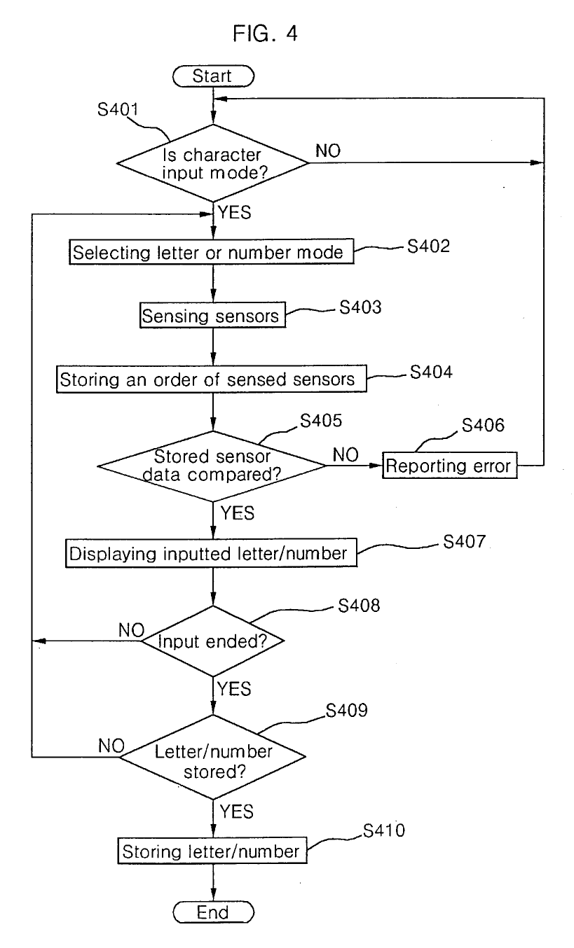

FIG. 4 is a flowchart of an embodiment of a method for inputting and recognizing characters using the character input apparatus shown in FIGS. 2 and 3 according the present invention.

First, the user selects a mode to input character (S401). To select character input mode, a determined key is used or a separate mode switch key to switch into the character input mode is prepared and used. In the character input mode, the user determines to input letters such as Hangul or English alphabet or numbers (S402).

Here, the step S402 can be omitted. In other words, as shown in FIG. 4, the system (microcomputer) distinguishes letters from numbers using touch order of sensors with no relation to inputting letters or numbers with five sensors S1 to S5. At this time, the selection of letter or number input modes is not necessary contrary to the step S402. However, since the sensor touch order of a specific letter can be the same as that of a specific number, it is desired that letter or number input modes are selected to make it clear as the step S402.

After that, when the letter or number modes are selected and the user writes a predetermined character directly on the sensors S1 to S5 of character input unit 210, the microcomputer recognizes the sensor order successively from the first contacted sensor according to touch order (S403) and stores the touch order of the sensed sensors (S404). When the stored touch order is compared with the deliberately stored sensor data and the matched data are found, the microcomputer recognizes that a letter or a number is inputted (S405).

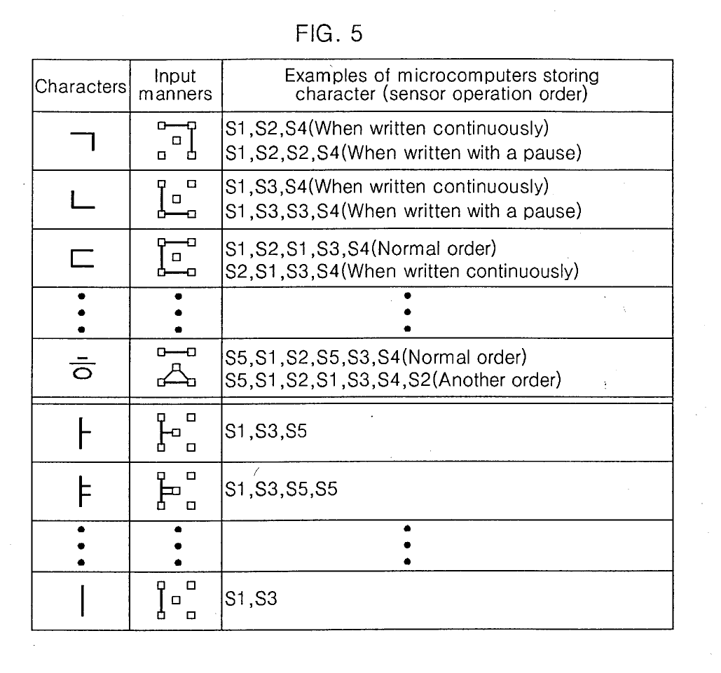

Here, the sensor data may be the database in which every character is mapped on its touch orders of the sensors that should be touched or can be touched when writing the character. For example, as shown in FIG. 5, the database is constructed that includes the touch orders of the sensors which should be touched or can be touched when writing a specific character using the five sensors S1 to S5. As another embodiment, the touch order can be decoded directly and recognized as a specific character to display the result of recognition.

The recognized touch order is compared with the stored character correspondence touch order data to recognize what character is inputted. The recognized character data are stored in the memory 382 and displayed by the display unit 383 to report them to the user (S407 to S410).

In other words, in the step S405, if the inputted touch order is compared with the stored touch order data and the matched data are not found, an error is reported and it goes to the step 401. If the inputted touch order is compared with the stored touch order data and the matched data are found, the display unit 383 displays the character and confirms it to the user (S407). If the user confirms the displayed character and selects input end (or input completion) and storage (S408 and S409), the corresponding letter or number data are stored on the memory 383 (S410) since the character that the user would like to input is recognized correctly. Otherwise, it goes to the step 402 and character input and recognition is repeated.

Here, in the step S402 of selecting letter or number input modes, the previously selected input mode is selected as a default mode so that letter input is required in the letter input mode. Number input is required in the number input mode so that inconvenience to select a mode is removed.

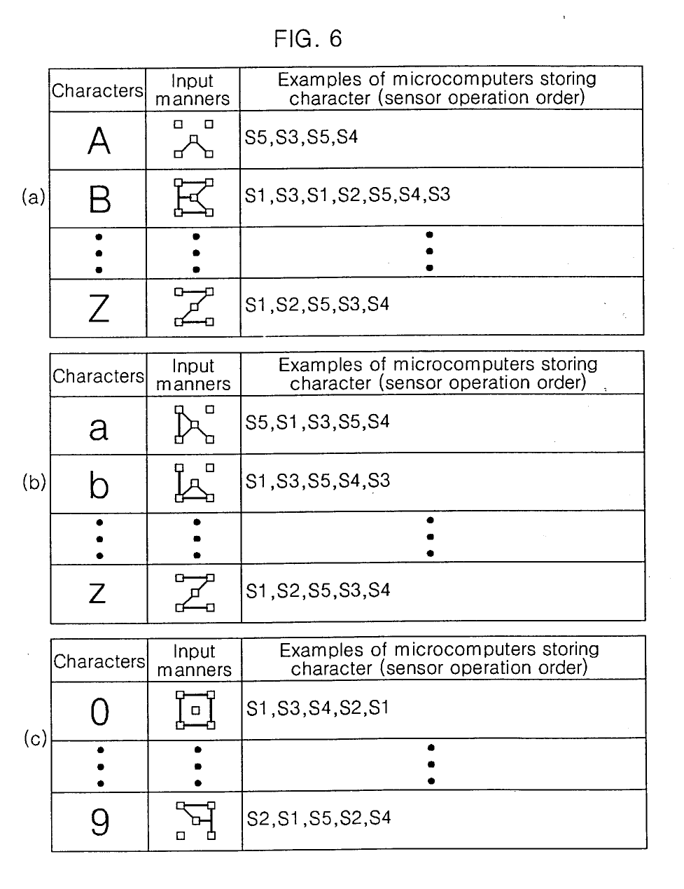

FIGS. 5 and 6a though 6c illustrate examples of writing characters and recognizing written characters based on the five sensors S1 to S5 of FIG. 2. In other words, as shown in FIG. 5, in the case of Hangul ‘ [symbol] ’, the touch order of the sensors S1 to S5 is S1-S2-S4 when writing a horizontal stroke (line) and a vertical stroke (line) continuously, or S1-S2-S2-S4 when writing a horizontal stroke and a vertical stroke with a pause by the user's habit.

As shown in FIG. 6a, in the case of English alphabet ‘A’, the touch order of the sensors S1 to S5 is S5-S3-S5-S4. As another embodiment, the touch order of ‘A’ can be S3-S4-S5 or the like according to the user's input order.

As another embodiment, in the case of small letters, the large letter mode can be applied to the small letter input mode or letter data can be prepared for the small letters. Here, when the small letters are recognized with the separate letter data, for example, ‘a’ can be S5-S1-S3-S5-S4 or the like and ‘b’ can be S1-S3-S5-S4-S3 or the like.

In the case of number, number can be recognized through the touch order on a letter input panel. For example, ‘0’ can be S1-S3-S4-S2-S1. As shown in FIG. 2, the key buttons or number recognition sensors as number keys can be prepared around the character input unit 210 separately. The number keys include ten number keys and two function keys that can be a mode switch key (*) and a Korean/English switch or arrow key (#).

Accordingly, the touch order of the sensor S1 to S5 can be recognized when the user writes Hangul consonant/vowel, English large letter/small letter and number on the character input unit 210. The character that the user inputs can be recognized according to the touch order.

Thus, if the touch order of the sensors is decoded, the corresponding character can be recognized. Or as shown in FIGS. 2 and 4, the touch order data corresponding to character (letters and numbers) are stored as database in the memory. The recognized the touch order of the sensors is compared with the data and the specific character can be recognized using the comparison result.

As an embodiment, in character recognition using six sensors, various character correspondence patterns are stored according to each character input method. When the user inputs characters on six sensors, the combination of the touch sensors is compared with character patterns to recognize the corresponding character. Here, if different characters have the same character pattern, the character can be recognized correctly using the first touch information of the touch order data, the last touch information of the touch order data and the character pattern touch.

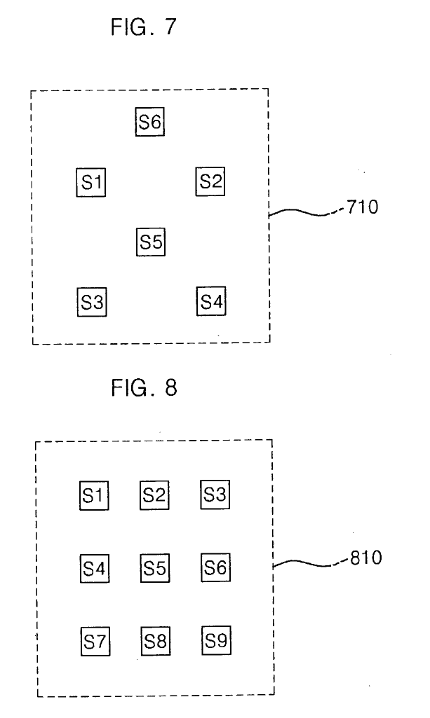

FIGS. 5 and 6a through 6c illustrate various embodiments of a character input means. FIG. 7 illustrates a character input unit 710 that has six touch sensors S1 to S6 by adding a sensor S6 to an upper middle portion in the five sensors arrangement shown in FIG. 5. In this case, one dot stroke can be inputted more effectively when inputting letters.

FIG. 8 illustrates a character input unit 810 that has nine touch sensors S1 to S9 arranged in 3×3 matrix, that is, 3 sensors in horizontal direction and 3 sensors in vertical direction. If nine sensors are arranged, more delicate written characters can be inputted but the recognition process to recognize the touch order of the sensors corresponding to inputted written character as the corresponding character can be more complex.

As another embodiment to recognize characters, the five sensors positioned as FIG. 2 of the nine sensors are grouped to be primary sensors and the remaining four sensors are grouped to be auxiliary sensors. The primary sensors are used to recognize a character. When the character failed to be recognized by the primary sensors due to the various character input manners of the user, the touch order of the auxiliary sensors are also considered and the character can be recognized using the touch order of the whole nine sensors.

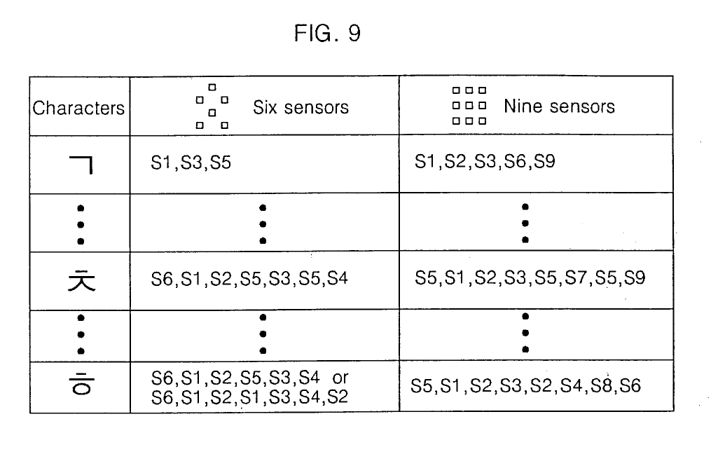

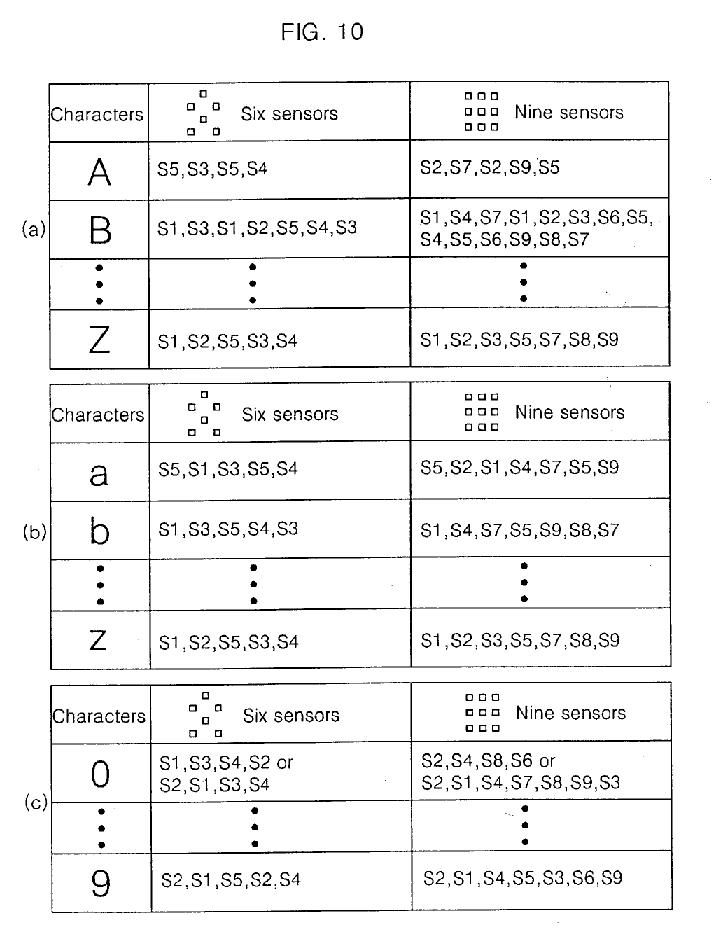

FIGS. 9 and 10a through 10c illustrate examples of input and recognition of characters using six sensors or nine sensors shown in FIGS. 7. and 8.

In the case of arrangement and structure of six sensors shown in FIG. 7, for example, Hangul such as ‘ [symbol] ’ can be more easily inputted owing to the sixth sensor S6

In the case of arrangement and structure of nine sensors shown in FIG. 8, for example, it allows the user to write and input very delicate letter near to reality but it requires more abundant database than those of five sensors and six sensors to recognize the character since even the same character can be written in various patterns (the sensors which can be touched, the number of the sensors, touch orders) according to the user's habit.

Here, when using nine sensors, the touch order of the character is decoded to recognize the corresponding character or character patterns (combination of the touch sensors) stored in the memory are used to recognize the corresponding character.

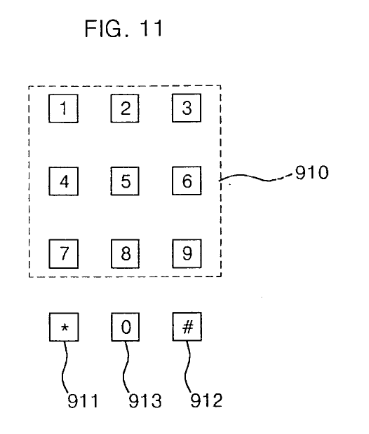

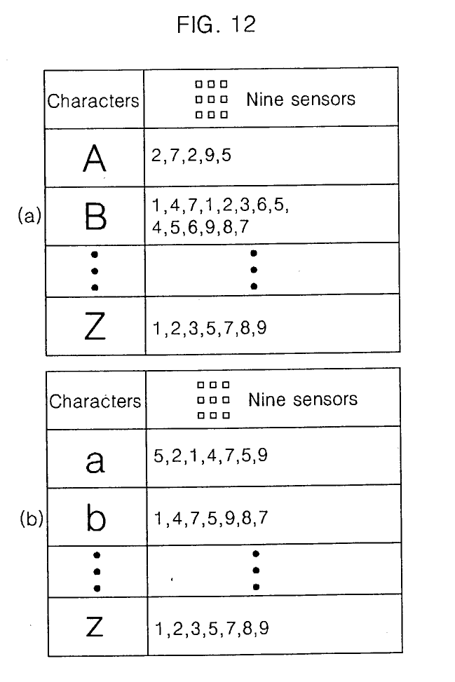

FIG. 11 illustrates inputting and recognizing characters using 3×3 key matrix of 3×4 key matrix as another embodiment of the present invention. FIGS. 12a and 12b illustrate examples of inputting and recognizing characters shown in FIG. 11.

Referring to FIGS. 11, 12a and 12b, the nine buttons arranged in 3×3 matrix are used as a character input unit 910. Number button ‘0’, mode switch key ‘*’ and Korean/English switch key ‘#’ of remaining buttons are additionally prepared. These nine buttons are used to input character by selecting buttons corresponding to a character shape for different languages.

The buttons are selected according to the character shape using the buttons ‘1’ to ‘9’ shown in FIG. 11. The order or combination of the selected buttons is used to recognize character.

For example, as shown in FIG. 12, the letter ‘A’ is inputted by pressing the buttons ‘2’, ‘7’, ‘2’, ‘9’ and ‘5’ in this order. The letter ‘Z’ is inputted by pressing the buttons ‘1’, ‘2’, ‘3’, ‘5’, ‘7’, ‘8’ and ‘9’ in this order.

In addition, when the buttons are selected and inputted successively by the user according to the character shape, the microcomputer can recognize the character corresponding to the button order of character selection buttons. In another embodiment, the combination of various buttons corresponding to character shape is compared with character correspondence patterns stored in the memory and the matched pattern is found to recognize the character.

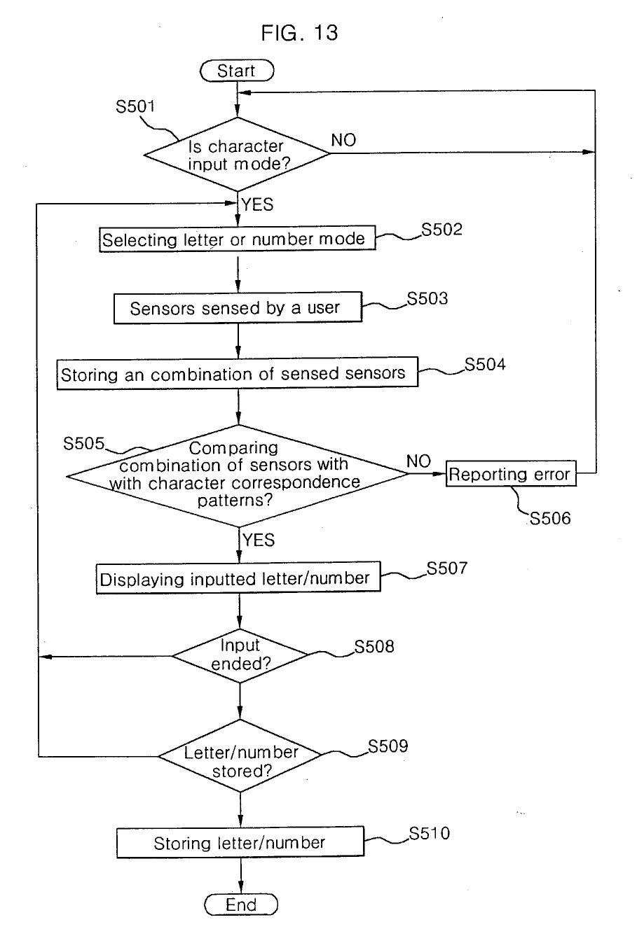

FIG. 13 is a flowchart of recognition of characters according to another embodiment of the present invention. FIG. 13 is an example of the process of recognizing characters based on FIGS. 8 and 11 suggested in the present invention.

First, the user selects a mode to input character (S501). The selection of character input mode can be performed using the previously set key or the separate mode switch key. The user determines to input letters such as Hangul or English alphabet or numbers (S502). Here, the step S502 can be omitted but it can be desired that letter or number modes are selected using mode switch key as the step S502 to make it clear.

Then, if letter mode is selected and the user touches the sensors (or the buttons) of the character input unit according to a predetermined character shape, the touched sensors are sensed in order (S403) and the combination of the sensed sensors is stored (S504). The stored combination of the touch sensors is compared with the character correspondence patterns. If the matched character data are found, it is recognized that a letter/number is inputted (S505).

The character correspondence patterns are input patterns of the many users for the peculiar shape of the character. For example, character correspondence patters according to the shape of character to be inputted on the character input unit comprised of nine sensors or buttons as shown in FIGS. 8 and 11 are constructed in database.

Similarly, the recognized touch combination is compared with the stored character correspondence patters to recognize the character that is inputted by the user. The recognized character data are stored in the memory and displayed by the display unit to report them to the user (S507 to S510).

In other words, in the step S505, if the combination of the sensed touch sensor is compared with the stored character correspondence patterns and the matched data are not found, an error is reported and it goes to the step 501. If the combination of the sensed touch sensor is compared with the stored character correspondence patterns and the matched data are found, the display unit 383 displays the character corresponding to the data and confirms it to the user (S507). If the user confirms the displayed character and selects input end (or input completion) and storage (S508 and S509), the corresponding letter or number data are stored on the memory (S510) since the character that the user would like to input is recognized correctly. Otherwise, it goes to the step 502 and character input and recognition is repeated.

Here, since FIG. 13 illustrates the case to input characters in the character shape using the number buttons, the device of the present invention can be operated in the letter (Hangul, English alphabet, or the like) input mode other than number input mode.

Thus, the present invention uses touch sensors or push buttons as input means and can recognize characters using the touch order of the touch sensors or the push order of the push buttons and also by comparison of selection combination of the touch sensors or the push buttons with character patterns stored in the memory.

The present invention provides convenient character input manner since the device of the present invention recognizes the characters written by the user without any separate character input means such as an input pen or the like to input character. The device of the present invention can input and recognize the character written by the user's finger with at least five sensors and does not require additional training course to input character.

As another embodiment, the character input apparatus provides the user with dictation mode to store the user's touch order of the dictated character and use them in recognizing characters. Character input error caused by the user's touch order is compared with the character inputted after error occurrence and analyzed to cope with the characters inputted in the same touch order that had caused the character input error.

Since the character is recognized in response to the touch order of the sensors corresponding to the character written by the user's finger using at least five sensor, it does not require too much memory capacity to recognize the character and the character recognition ratio and the recognition speed are improved.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A character input apparatus comprising:
a sensor means for sensing a hand's touch of a user who writes characters to input the characters;
a character recognition and control means for recognizing the inputted character according to a touch order of the sensor means;
a storage means for storing data of the recognized character; and
a display means for displaying the stored data of the character recognized by the character recognition and control means on a screen.

2. The character input apparatus according to claim 1, wherein the sensor means is a touch sensor.

3. The character input apparatus according to claim 1, wherein the sensor means comprises five touch sensors arranged at four corners of a rectangle and a center of the rectangle.

4. The character input apparatus according to claim 1, wherein the sensor means comprises nine touch sensors arranged in 3×3 matrix.

5. The character input apparatus according to claim 1, wherein the character recognition and control means decodes the touch order of the sensor means and recognizes a character.

6. A character input apparatus comprising:
a sensor means for sensing a hand's touch of a user who touches a plurality of touch sensors thereof arranged and spaced from each other with a predetermined distance;
a character recognition and control means for comparing combination of the touched sensors of the sensor means with stored character correspondence patterns and recognizing a character;
a memory for storing a character pattern corresponding to the hand's touch of the user; and
a display means for displaying the character recognized by the character recognition and control means on a screen.

7. The character input apparatus according to claim 6, wherein the sensor means comprises nine touch sensors arranged in 3×3 matrix.

8. A character input apparatus comprising:
a character input means having a plurality of key buttons for allows a user to input character by selecting the key buttons corresponding to character shape;
a character recognition and control means for recognizing the inputted character according to order of the selected key buttons;
a storage means for storing data of the recognized character; and
a display means for displaying, the stored data of the character recognized by the character recognition and control means on a screen.

9. The character input apparatus according to claim 8, wherein the sensor means comprises nine touch sensors arranged in 3×3 matrix.

10. A character input apparatus comprising:
a character input means for allows a user to input character by selecting buttons corresponding to character shape using a predetermined number of buttons on a key pad;
a character recognition and control means for comparing combination of the selected buttons with stored character correspondence patterns and recognizing the inputted character;
a memory for storing patterns of buttons corresponding to the inputted characters; and
a display means for displaying the stored data of the character recognized by the character recognition and control means on a screen.

11. The character input apparatus according to claim 10, wherein the sensor means comprises nine touch sensors arranged in 3×3 matrix.

12. A character input method comprising the steps of:
(a) when a user touches a plurality of sensors arranged and spaced from each other with a predetermined distance, sensing a touch order of the sensors corresponding to a character which the user writes by hand;
(b) recognizing a character corresponding to the sensed touch order; and
(c) storing and displaying data of the recognized character.

13. The character input method according to claim 12, wherein the step (b) comprises the steps of:
(b-1) decoding the user's touch order sensed by five touch sensors; and
(b-2) recognizing the character.

14. The character input method according to claim 12, wherein the step (b) comprises the steps of:
(b-1) decoding the user's touch order sensed by nine touch sensors; and
(b-2) recognizing the character.

15. A character input method comprising the steps of:
(a) sensing a user's hand touch to input characters by a plurality of sensors arranged and spaced from each other with a predetermined distance;
(b) comparing combination of the sensors corresponding to hand's touch with stored character correspondence patterns;
(c) recognizing a character corresponding to the combination of the sensors from character correspondence patterns according to a result of comparison; and
(d) displaying data of the recognized character on a screen.

16. The character input method according to claim 15, wherein the step (c) comprises the steps of:
(c-1) comparing combination of the touch sensors of the user sensed by five touch sensors with the character correspondence patterns stored in a memory; and
(b-2) recognizing the character corresponding to one of the character correspondence patterns.

17. The character input method according to claim 15, wherein the step (c) comprises the steps of:
(c-1) comparing combination of the touch sensors of the user sensed by nine touch sensors with the character correspondence patterns stored in a memory; and
(b-2) recognizing the character corresponding to one of the character correspondence patterns.

18. A character input method comprising the steps of:
(a) selecting buttons according to character shape using a predetermined number of buttons on a keypad;
(b) recognizing and storing an inputted character according to order of the selected buttons; and
(c) displaying data of the recognized and stored character on a screen.

19. The character input method according to claim 18, wherein the step (b) comprises the step of:
(b-1) recognizing the character according to an order of nine buttons arranged in 3×3 matrix on the keypad.

20. A character input method comprising the steps of:
(a) selecting buttons according to shape of a character to inputted using a predetermined number of buttons on a keypad;
(b) comparing combination of the selected buttons with character correspondence patterns stored in a memory, finding a character corresponding to one of the character correspondence patterns and recognizing the inputted character; and
(c) displaying the recognized character on a screen.

21. The character input method according to claim 18, wherein the step (b) comprises the steps of:
(b-1) finding the character correspondence pattern corresponding to the button selection combination of the nine buttons arranged in 3×3 matrix on the key pad; and
(b-2) recognizing the character corresponding to the character correspondence pattern.
